(19) United States
(12) Patent Application Publication
(10) Pub. No.: US 2015/0118533 A1
(43) Pub. Date: Apr. 30, 2015

(54) SECONDARY BATTERIES AND METHODS OF MANUFACTURING THE SAME

(71) Applicant: Samsung SDI Co., Ltd., Yongin-si (KR)

(72) Inventor: Jeong-Doo Yi, Yongin-si (KR)

(21) Appl. No.: 14/524,319

(22) Filed: Oct. 27, 2014

(30) Foreign Application Priority Data
Oct. 29, 2013 (KR) 10-2013-0129562

(51) Int. Cl. H01M 2/02; H01M 10/04

(52) U.S. Cl. CPC H01M 2/0202; H01M 10/0431; H01M 2/026; H01M 2/0287; H01M 10/0436; H01M 2220/30
USPC 429/94; 429/163; 29/623.2

(57) ABSTRACT

Provided is a secondary battery. The secondary battery includes: an electrode assembly including a positive electrode plate, a separator, and a negative electrode plate wound around a first axis extending in a first direction, having a thickness in a second direction perpendicular to the first direction and a length in a third direction perpendicular to the first direction and the second direction, and having a curvature with respect to the first axis while the length is greater than the thickness; an electrode case including a body and a cover having a curvature corresponding to the curvature of the electrode assembly and having different stiffnesses; and a first electrode tab and a second electrode tab connected respectively to the positive electrode plate and the negative electrode plate and protruding from the electrode assembly in a direction perpendicular to the first direction.

### CROSS-REFERENCE TO RELATED APPLICATIONS

This application claims the benefit of Korean Patent Application No. 10-2013-0129562, filed on Oct. 29, 2013, in the Korean Intellectual Property Office, the disclosure of which is incorporated herein in its entirety by reference.

### BACKGROUND

1. Field

One or more embodiments of the present invention relate to secondary batteries and methods of manufacturing the same.

2. Description of the Related Technology

In general, secondary batteries are rechargeable unlike primary batteries that are not rechargeable. Depending on the types of external devices to which secondary batteries are applied, the secondary batteries may be used in the form of a single battery or in the form of a module in which a plurality of unit batteries are connected and packed into one unit.

Recently, the types of electronic devices using secondary batteries have been diversified, and the designs of electronic devices have become an important factor in determining the purchase of electronic devices. For example, various wearable computers using secondary batteries as a power supply source, and applications thereof, have been developed and published. Also, electronic devices, such as mobile phones and laptop computers, have been designed to have curved surfaces for ergonomic purposes.

Secondary batteries for operating such electronic devices may need to be modified (for example, curved) according to the shapes of the electronic devices. In the case of a secondary battery modified according to the shape of an electronic device, a shape of the secondary battery may need to be maintained.

### SUMMARY OF CERTAIN INVENTIVE ASPECTS

One or more embodiments of the present invention include curved secondary batteries and methods of manufacturing the same.

Additional aspects will be set forth in part in the description which follows and, in part, will be apparent from the description, or may be learned by practice of the presented embodiments.

According to one or more embodiments of the present invention, a secondary battery includes: an electrode assembly including a positive electrode plate, a separator, and a negative electrode plate wound around a first axis extending in a first direction, having a thickness in a second direction perpendicular to the first direction and a length in a third direction perpendicular to the first direction and the second direction, and having a curvature with respect to the first axis while the length is greater than the thickness; an electrode case including a body and a cover having a curvature corresponding to the curvature of the electrode assembly and having different stiffnesses; and a first electrode tab and a second electrode tab connected respectively to the positive electrode plate and the negative electrode plate and protruding from the electrode assembly in a direction perpendicular to the first direction.

The body and the cover may be formed of different materials.

The body and the cover may be formed to have different thicknesses.

When a bottom of the body is convex and a top of the cover is concave, the stiffness of the body may be greater than the stiffness of the cover.

The body may be thicker than the cover.

The body may be formed of stainless steel, and the cover may be formed of aluminum.

When a bottom of the body is concave and a top of the cover is convex, the stiffness of the cover may be greater than the stiffness of the body.

The cover may be thicker than the body.

The cover may be formed of stainless steel, and the body may be formed of aluminum.

The battery case may be formed by using: a metal foil; and insulating films stacked on both sides of the metal foil.

The battery case may be a pouch including a sealing portion, and the first electrode tab and the second electrode tab may extend through the sealing portion.

According to one or more embodiments of the present invention, a secondary battery includes: a battery case including a body and a cover having different stiffnesses, wherein the cover is bound to the body and a bottom of the body and a bottom of the cover have a curvature in a same direction; an electrode assembly received in the battery case while having a curvature corresponding to the curvature of the battery case, and including a positive electrode plate, a separator, and a negative electrode plate; and a first electrode tab and a second electrode tab protruding from the electrode assembly.

When the bottom of the body and the bottom of the cover have a convex curvature, the stiffness of the body may be greater than the stiffness of the cover.

The body may be thicker than the cover.

When the bottom of the body and the bottom of the cover have a concave curvature, the stiffness of the cover may be greater than the stiffness of the body.

The cover may be thicker than the body.

According to one or more embodiments of the present invention, a method of manufacturing a secondary battery includes: forming a battery case including a body and a cover having different stiffnesses, wherein a bottom of the body and a bottom of the cover have a curvature in a same direction; receiving an electrode assembly including a positive electrode plate, a separator, and a negative electrode plate, in the battery case; and forming the electrode assembly having a curvature corresponding to the curvature of the battery case.

When the bottom of the body and the bottom of the cover have a convex curvature, the stiffness of the body may be greater than the stiffness of the cover.

When the bottom of the body and the bottom of the cover have a concave curvature, the stiffness of the cover may be greater than the stiffness of the body.

The body and the cover may have different thicknesses.

### BRIEF DESCRIPTION OF THE DRAWINGS

These and/or other aspects will become apparent and more readily appreciated from the following description of the embodiments, taken in conjunction with the accompanying drawings in which:

FIG. 1 is a schematic perspective view of a secondary battery including a battery case according to an embodiment of the present invention;

FIG. 2 is a schematic perspective view of a secondary battery including a battery case according to another embodiment of the present invention; and

FIGS. 3 to 8 are schematic diagrams illustrating a method of manufacturing a secondary battery according to an embodiment of the present invention.

### DETAILED DESCRIPTION OF CERTAIN INVENTIVE EMBODIMENTS

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, expressions such as “at least one of,” when preceding a list of elements, modify the entire list of elements and do not modify the individual elements of the list.

The effects and features of the present invention and the accomplishing method thereof will become apparent from the following description of the embodiments, taken in conjunction with the accompanying drawings. The inventive concept may, however, be embodied in many different forms and should not be construed as being limited to the embodiments set forth herein; rather, these embodiments are provided so that this disclosure will be thorough and complete, and will fully convey the inventive concept to those of ordinary skill in the art. Therefore, the scope of the inventive concept is defined not by the detailed description of the inventive concept but by the appended claims. The terminology used herein is for the purpose of describing the embodiments only and is not intended to be limiting of the embodiments. As used herein, the singular forms “a,” “an” and “the” are intended to include the plural forms as well, unless the context clearly indicates otherwise. It will be further understood that the terms “comprise” and “comprising” used herein specify the presence of stated elements, steps, operations, or devices, but do not preclude the presence or addition of one or more other elements, steps, operations, or devices. Although terms such as “first” and “second” may be used herein to describe various elements or components, these elements or components should not be limited by these terms. These terms are only used to distinguish one element or component from another element or component.

Hereinafter, embodiments of the present invention will be described in detail with reference to the accompanying drawings so that those of ordinary skill in the art may easily understand the inventive concept.

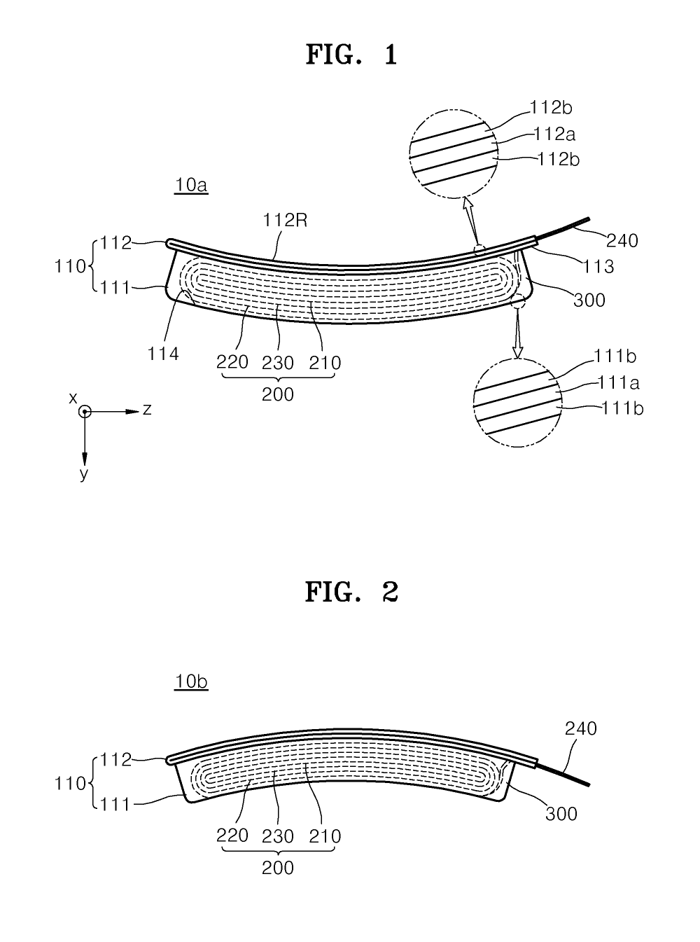

FIG. 1 is a schematic perspective view of a secondary battery 10a including a battery case 110 according to an embodiment of the present invention.

Referring to FIG. 1, the secondary battery 10a includes an electrode assembly 200 and a battery case 110.

The electrode assembly 200 is received in the battery case 110 together with an electrolyte 300. A first electrode tab 240 and a second electrode tab (not illustrated) of the electrode assembly 200 are exposed to the outside of the battery case 110 through a sealing portion of the pouch-type battery case 110.

The electrolyte 300 may be formed by dissolving various additives, such as lithium salts (LiPF₆ and LiBF₄), in an organic solvent. The electrolyte 300 may be any that may dissolve a sufficient amount of lithium salt and has low viscosity. In particular, the electrolyte 300 may need to be inert on the surfaces of a positive electrode plate 210 and a negative electrode plate 220 in a charge/discharge process of the secondary battery 10a. For example, the electrolyte 300 may include at least one of ethylene carbonate (EC), propylene carbonate (PC), dimethyl carbonate (DMC), diethyl carbonate (DEC), and ethyl methyl carbonate (EMC).

Also, a polymer gel that is a solid electrolyte may be used as the electrolyte 300. Since the electrolyte 300 using a polymer gel has a high boiling point, it is robust against combustion and may prevent electrolyte leakage. For example, the polymer gel may include at least one of polyethylene glycol (PEG), polyacrylonitrile (PAN), polymethylmethacrylate (PMMA), and polyvinyldifluoride (PVDF).

The polymer gel may be formed by a gelling reaction of a polymer precursor (prepolymer). The polymer precursor is a prepolymer. In detail, the polymer gel may be formed by receiving a polymer precursor in the battery case 110 and heating the battery case 110 in which the polymer precursor is received.

In the present embodiment, when the polymer gel is used as the electrolyte 300, the battery case in which the electrode assembly 200 and the electrolyte 300 are received may be curved in a direction parallel to a winding direction of the electrode assembly 200, and then a thermal curing process may be performed thereon.

In the present embodiment, the battery case 110 is a flexible pouched case, and includes a body 111 and a cover 112 bound to the body 111. The body 111 and the cover 112 are integrated and bound with each other on at least one side. The battery case 110 includes metal foils 111a and 112a and insulating films 111b and 112b stacked on both sides of the metal foils 111a and 112a; however, embodiments of the present invention are not limited thereto.

The body 111 and the cover 112 may be formed to have different stiffnesses. To this end, the body 111 and the cover 112 may be formed of different materials, or may be formed of the same material to have different thicknesses.

The secondary battery 10a may be manufactured by receiving the electrode assembly 200 in a receiving portion of the body 111 and thermally bonding a bonding portion 113 while closely adhering the body 111 and the cover 112.

In the present embodiment, the pouch may be formed in a foldable integrated type. In this case, the pouch may be sealed through the bonding portion 113 at a first side surface, a second side surface, and a third side surface connecting the first side surface and the second side surface and may include the cover 112 forming a fourth side surface facing the third side surface between the first side surface and the second side surface; and the first electrode tab 240 and the second electrode tab (not illustrated) may extend on the third side surface through the bonding portion 113 that is a sealing portion.

As illustrated in FIG. 1, when the secondary battery 10a is formed such that the electrode assembly 200 has a convex bottom and a concave top, the body 111 may be formed of a material having a greater stiffness than a material of the cover 112. The stiffness is k=F/δ (where k denotes a stiffness [N/m], F denotes an external force [N] applied to the material, and δ denotes a displacement [m] corresponding to the external force) that is an index representing the degree of resistance of the material against deformation. When the material has a greater stiffness, the material may better maintain an original shape.

Also, the stiffness may be represented by k=AE/L (where A denotes a cross-sectional area, E denotes a Young's modulus, and L denotes the length of the material). It may be seen that the stiffness k may be proportional to the product of the Young's modulus and the cross-sectional area.

Table 1 below illustrates a Young's modulus depending on the thickness of a pouch formed of a metal and an insulating film (for example, a polymer) and the type of the metal.

TABLE 1

| Total Thickness | Thickness of Metal | Type of | Young's modulus |
|---|---|---|---|
| (μm) | (μm) | Metal | (GPa) |
| 88 | 35 | Al | 6.48 |
| 51 | 15 | SUS | 42.33 |
| 113 | 51 | SUS | 33.91 |

Referring to Table 1, it may be seen that a steel use stainless (SUS) pouch has a greater Young's modulus than an aluminum (Al) pouch. Thus, it may be seen that the SUS pouch provides a greater stiffness than the aluminum pouch. Also, as described above, the stiffness is proportional to the product of the Young's modulus and the cross-sectional area. Thus, the SUS pouch has the smaller Young's modulus at the greater thickness, but has the greater stiffness due to a cross-sectional area increase according to a thickness increase. Therefore, even when the pouch is formed of the same material, the stiffness may be increased by increasing the cross-sectional area, for example, the thickness.

The electrode assembly 200 is formed to have a curved shape. However, in the electrode assembly 200, due to the swelling of the positive electrode plate 210 and the negative electrode plate 220, a force is generated to deform the curved shape into a flat shape. Therefore, the original shape of the secondary battery 10a may not be maintained.

However, according to the present embodiment, since the body 111 and the cover 112 of the battery case 110 are formed of different materials having different stiffnesses, the deformation of the shape of the secondary battery 10a may be prevented or inhibited.

For example, the cover 112 may be formed of aluminum, and the body 111 may be formed of SUS. Since SUS has a greater stiffness than aluminum, an increase in the curvature radius may be suppressed when the cover 112 is flattened.

Table 2 below illustrates a change in the curvature radius of a curvature 112R according to charge/discharge cycles, when the secondary battery 10a has a horizontal (x direction; curved direction) length of about 1.5 cm, a vertical (z direction; direction perpendicular to the curved direction) length of about 3 cm, a thickness (y direction) of about 4 mm, and a curvature radius of about 25.7 mm, and the cover 112 and the body 111 are formed of aluminum (total thickness: about 88 μm; thickness of aluminum: about 35 μm).

TABLE 2

| Cycle | 1 | 10 | 50 | 150 | 300 |
|---|---|---|---|---|---|
| Curvature Radius (mm) | 25.7 | 27.5 | 29.0 | 30.4 | 32.7 |
| Increase Rate (%) | 0.0 | 7.1 | 12.9 | 18.6 | 27.2 |

Referring to Table 2, it may be seen that the curvature radius of the secondary battery 10a gradually increases when the battery case 110 is formed of the same material. The gradual increase in the curvature radius means that the secondary battery 10a having a predetermined curvature 112R is gradually deformed into a flat shape.

In order to prevent the change in the curvature radius according to charge/discharge cycles, the thickness of the battery case 110 may be increased. However, in terms of the small size and the light weight of a product, there is a limit in increasing the thickness of the secondary battery 10a.

Therefore, the battery case 110 may be formed such that the cover 112 and the body 111 have different stiffnesses.

For example, when formed of aluminum (total thickness: about 88 μm; thickness of aluminum: about 35 μm), the battery case 110 has a stiffness of about 36.6 N/cm. The battery case 110 may have a stiffness of about 99.6 N/cm greater than the above stiffness (about 36.6 N/m) so that the curvature radius of the cover 112 may be deformed within a range of about 10% according to the charge/discharge cycles of the battery case 110.

To this end, the total thickness of the battery case 110 may be increased so that the battery case 110 may have a stiffness of about 99.6 N/cm. However, for the small size and the light weight of the product, without increasing the total thickness of the battery case 110, the battery case 110 may be formed such that the body 111 and the cover 112 have different stiffnesses.

For example, without changing the material of the cover 112, the body 111 may be formed of SUS having a greater stiffness than aluminum. When the body 111 has a thickness of about 51 μm (thickness of SUS: about 15 μm), the body 111 has a stiffness of about 91.2 N/cm. When the body 111 has a thickness of about 113 μm (thickness of SUS: about 51 μm), the body 111 has a stiffness of about 177 N/cm. It is assumed that the influence of a polymer on the stiffness is smaller than the influence of SUS on the stiffness in the body 111, and the stiffness of the body 111 linearly increases with the thickness of SUS. In this case, when the body 111 is formed of SUS having a thickness of about 18.52 μm or more, the deformation of the curvature radius may be maintained within a range of about 10%. Therefore, the body 111 may be formed of a material different from the material of the cover 112, to maintain the curvature radius of the secondary battery 10a within a predetermined range.

Although it has been described above that the battery case 110 is formed of different materials, embodiments of the present invention are not limited thereto. Since the stiffness is proportional to the cross-sectional area, the battery case 110 may be formed of the same material such that the body 111 and the cover 112 have different thicknesses and different stiffnesses. That is, the body 111 may be formed to be thicker than the cover 112 so that the body 111 may have a greater stiffness than the cover 112.

A force is generated in a downward direction at both ends of the electrode assembly 200, to flatten the electrode assembly 200 formed to have a concave top and a convex bottom. However, since the body 111 is formed of a material having a greater stiffness than the material of the cover 112, the electrode assembly 200 may be prevented from being deformed by the force generated in the downward direction of the electrode assembly 200.

FIG. 2 is a schematic perspective view of a secondary battery 10b including a battery case 110 according to another embodiment of the present invention.

In FIGS. 1 and 2, like reference numerals denote like elements, and a redundant description thereof will be omitted.

Referring to FIG. 2, the secondary battery 10b includes an electrode assembly 200 and a battery case 110.

The electrode assembly 200 has a concave bottom and a convex top, and the battery case 110 receiving the electrode assembly 200 has a shape corresponding to the shape of the electrode assembly 200.

A force is generated in an upward direction at both ends of the electrode assembly 200, to flatten the electrode assembly 200 formed to have a curvature.

However, according to the present embodiment, since the battery case 110 is formed such that the cover 112 has a greater stiffness than the body 111, the deformation of the secondary battery 10b may be prevented.

For example, the body 111 may be formed of aluminum, and the cover 112 may be formed of stainless steel having a greater stiffness than aluminum. However, embodiments of the present invention are not limited thereto, and the body 111 and the cover 112 may be formed of the same material to have different thicknesses and different stiffnesses.

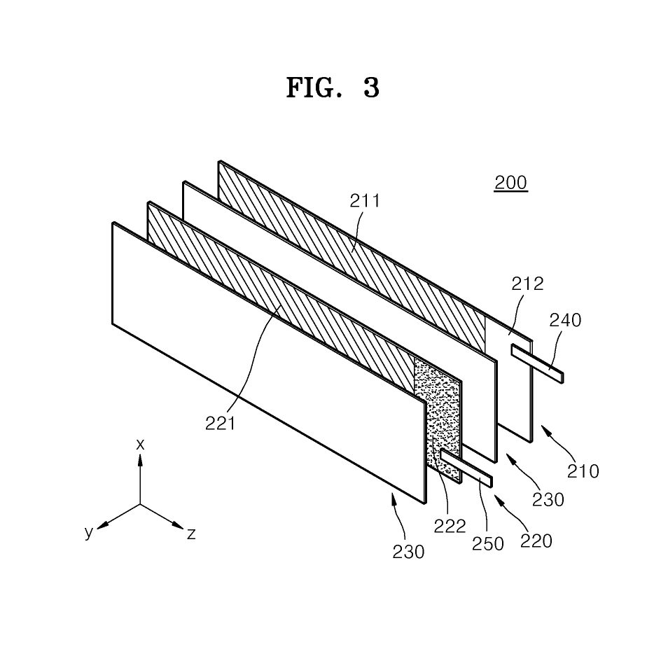

FIGS. 3 to 8 are schematic diagrams illustrating a method of manufacturing a secondary battery according to an embodiment of the present invention.

Referring to FIG. 3, an electrode assembly 200 includes a positive electrode plate 210, a negative electrode plate 220, and a separator 230.

A first electrode tab 240 and a second electrode tab 250 are attached respectively to the positive electrode plate 210 and the negative electrode plate 220 to form a direct electrical connection with the outside, or it is electrically connected to the outside through a separate electrode lead (not illustrated).

The positive electrode plate 210 includes, on one side or both sides of a positive electrode collector, a positive electrode active material layer 211 coated with a positive electrode active material, and a first uncoated portion 212 that is not coated with the positive electrode active material.

In general, the positive electrode collector may be any material that has high conductivity and does not induce a chemical change. For example, the positive electrode collector may include aluminum, nickel, titanium, or sintered carbon. However, embodiments of the present invention are not limited thereto. The positive electrode active material layer 211 is formed by generating a slurry by mixing a positive electrode active material, which is a lithium-containing layered compound, a conductive material for improving conductivity, and a binder for improving a binding force of materials, with a solvent, and coating the positive electrode collector with the slurry.

The negative electrode plate 220 includes, on one side or both sides of a negative electrode collector, a negative electrode active material layer 221 coated with a negative electrode active material, and a second uncoated portion 222 that is not coated with the negative electrode active material.

In general, the negative electrode collector is a conductive metal plate, and may be formed of, for example, copper, stainless steel, aluminum, or nickel. However, embodiments of the present invention are not limited thereto. The negative electrode active material layer 221 is formed by generating a slurry by mixing a negative electrode active material and a binder for improving a binding force of the negative electrode active material, with a solvent, and coating the negative electrode collector with the slurry.

The separator 230 is interposed between the positive electrode plate 210 and the negative electrode plate 220. The separator 230 is an insulating thin film having high ion permeability and high mechanical strength. The separator 230 functions as an ion channel and prevents the positive electrode plate 210 and the negative electrode plate 220 from directly contacting each other. For example, the separator 230 may include polyethylene, polypropylene, or polyvinylidene fluoride. However, embodiments of the present invention are not limited thereto.

The first and second electrode tabs 240 and 250 may be attached to the first and second uncoated portions 212 and 222 of the positive electrode plate 210 and the negative electrode plate 220 by at least one of ultrasonic welding, resistance welding, and laser welding, or may be formed to be integrated with the positive electrode plate 210 and the negative electrode plate 220. For example, the first and second electrode tabs 240 and 250 may be formed of nickel or aluminum. However, embodiments of the present invention are not limited thereto.

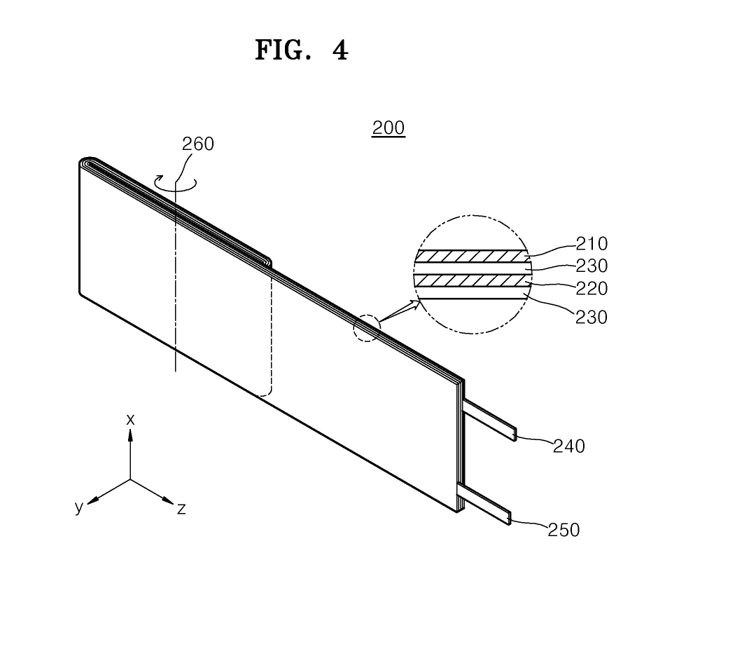

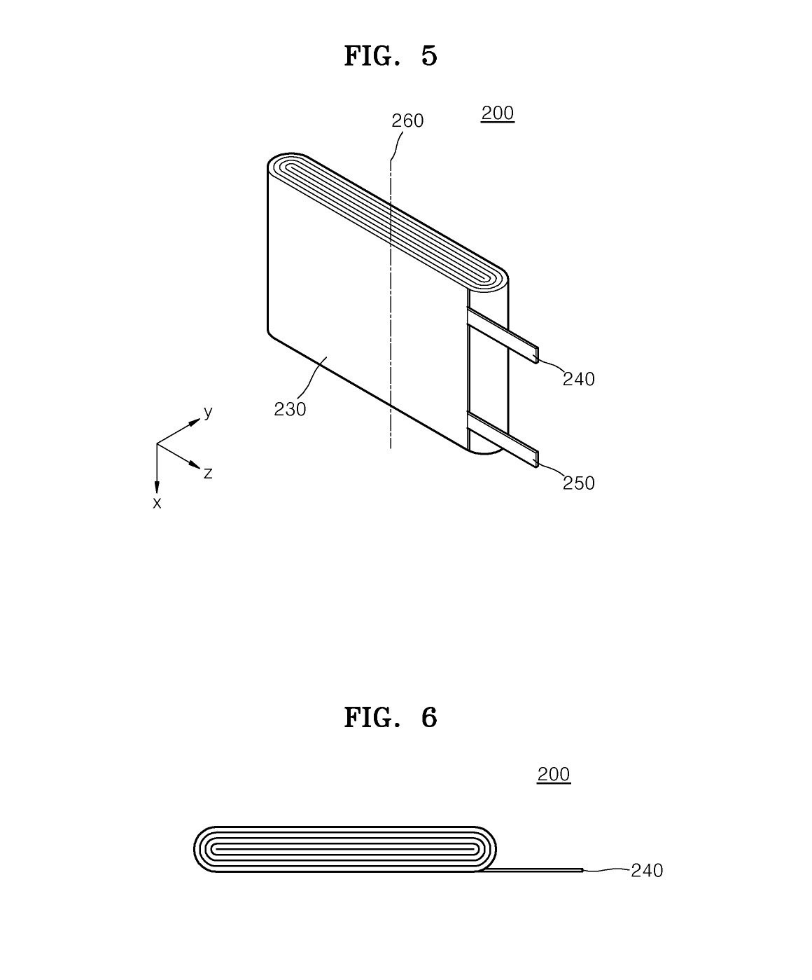

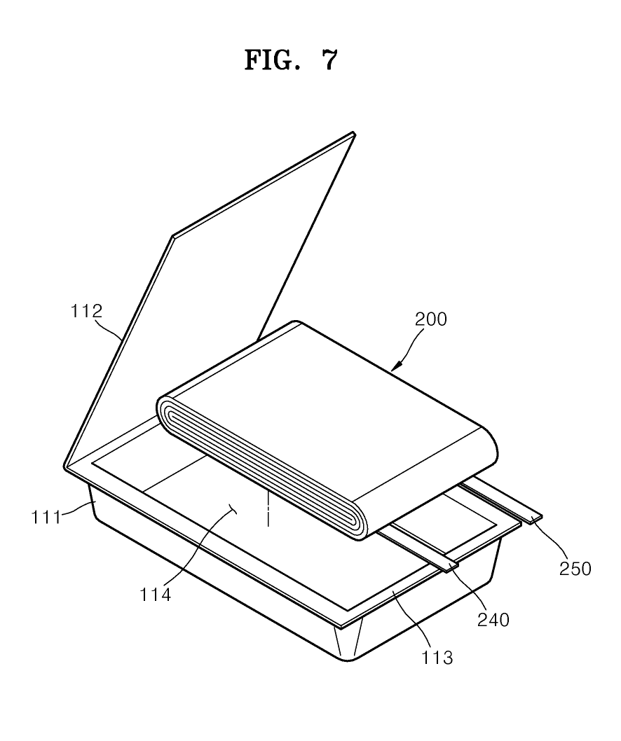

FIG. 5 is a perspective view of an electrode assembly wound according to FIG. 4, and FIG. 6 is a side view of the electrode assembly.

Referring to FIGS. 4 to 6, the electrode assembly 200 includes the positive electrode plate 210, the separator 230, and the negative electrode plate 220 that are wound around a first axis 260 in a first direction (x). The electrode assembly 200 has a thickness in a second direction (y) perpendicular to the first direction (x) and a length in a third direction (z) perpendicular to the first direction (x) and the second direction (y), wherein the length is greater than the thickness.

Referring to FIG. 5, the first and second electrode tabs 240 and 250 attached respectively to the positive electrode plate 210 and the negative electrode plate 220 are exposed to the outside through the outermost shell of the wound electrode assembly 200, and extend in a direction parallel to the winding direction. Also, as illustrated in FIG. 6, the electrode assembly 200 may have an elliptical cross section.

Referring to FIG. 7, the wound electrode assembly 200 is received in the battery case 110 formed such that the body 111 and the cover 112 have different stiffnesses. The first electrode tab 240 and the second electrode tab 250 of the electrode assembly 200 are exposed to the outside of the battery case 110.

Since the electrode assembly 200 is formed to have a concave top and a convex bottom, the body 111 may be formed of a material having a greater stiffness than the material of the cover 112, in order to prevent the deformation of the electrode assembly 200. For example, the body 111 may be formed of stainless steel, and the cover 112 may be formed of aluminum. As another example, the cover 112 body 111 may be formed of the same material as the cover 112, but may be formed to have a greater thickness than the cover 112 in order to have a greater stiffness than the cover 112.

The first electrode tab 240 and the second electrode tab 250 provide an electrical connection with the outside by moving electrons generated by the chemical reaction between the electrode plates and the electrolyte. The first electrode tab 240 and the second electrode tab 250 extend in parallel to the winding direction of the electrode plates.

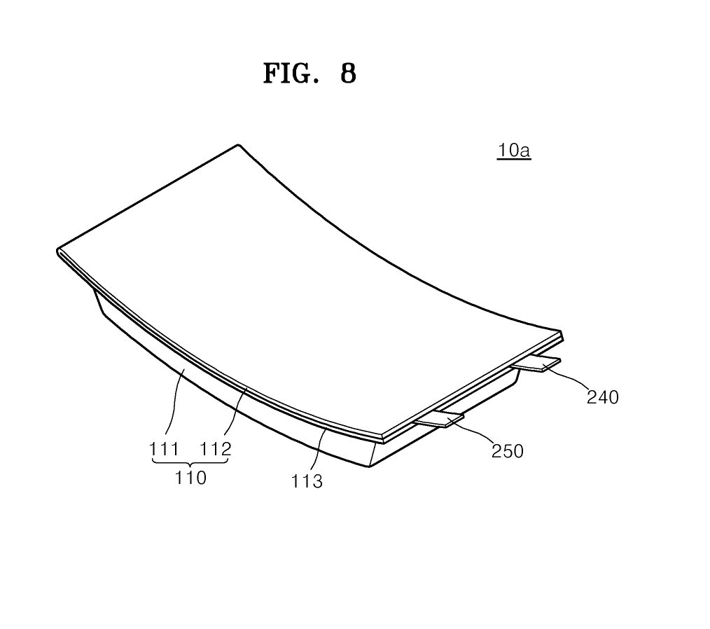

Referring to FIG. 8, the electrode assembly 200 and the electrolyte (not illustrated) are received in the pouched battery case 110, and then the battery case 110 is sealed by, for example, thermal bonding.

In detail, the bonding portion 113 of the battery case 110 and the cover 112 contacting the bonding portion 113 are heated to a predetermined temperature or more while being pressed by a pressing jig. In this case, the first and second electrode tabs 240 and 250 are exposed through the bonding portion 113. Also, as illustrated, the first and second electrode tabs 240 and 250 are spaced apart from each other.

Thereafter, curvature deformation is performed to form a curved secondary battery 10a. In detail, around a winding axis 260 (see FIG. 5) of the electrode assembly 200, a cross section perpendicular to the winding axis 260 and both ends is smoothly curved in the same direction with respect to a center portion. That is, both ends of the electrode assembly 200 may be curved downward around the center portion with respect to a horizontal plane.

As illustrated in FIG. 8, by curving the secondary battery 10a receiving the electrode assembly 200, the battery case 110 and the electrode assembly 200 located in the battery case 110 are also curved. The curving direction of the electrode assembly 200 is parallel to the winding direction of the electrode assembly 200. As illustrated, in the electrode assembly 200, a surface perpendicular to the first and second electrode tabs 240 and 250 is narrow, but a surface parallel to the first and second electrode tabs 240 and 250 is relatively wide. That is, a curved portion of the electrode assembly 200 is curved with respect to a relatively greater width. Accordingly, since the force applied to the electrode assembly 200 is distributed, the electrode assembly 200 may be prevented from being damaged.

The electrolyte used may be a general liquid electrolyte or a solid electrolyte. When a solid electrolyte is used, a thermal curing process may be performed after the secondary battery 10a is curved.

That is, when a polymer gel is used as the solid electrolyte in the secondary battery 10a, a thermal curing process is performed after the polymer precursor (prepolymer) and the electrode assembly 200 are received in the battery case 110. By the thermal curing process, the polymer precursor becomes a polymer gel. The thermal curing process may be performed after the electrode assembly 200 is curved. Since the polymer gel is formed of bridged polymers, the strength of the secondary battery 10a is increased by the polymer gel. Therefore, the secondary battery 10a may be stably used because it is not easily deformed by an external impact.

On the other hand, a problem may arise when the polymer precursor is thermally cured before the secondary battery 10a is curved. In detail, the fluidity of the thermally-cured polymer gel may be reduced. Therefore, the polymer gel may stiffen the surface of the electrode assembly 200 and a peripheral portion thereof. That is, when the electrode assembly 200 is curved after the polymer gel is thermally cured, the active material layers of the first and second electrode plates of the electrode assembly 200 may be delaminated. On the other hand, according to the present embodiment, the polymer precursor is a solution when the electrode assembly 200 is formed to have a curvature, that is, before the thermally cured state. Therefore, such problems may be prevented when the electrode assembly 200 is curved and the electrolyte is a polymer precursor.

The secondary battery 10a may be curved by pressing and heat-treating the secondary battery 10a. Herein, the pressing and heat-treating temperature may be set to minimize the degradation of the electrolyte and the electrode assembly 200 received in the secondary battery 10a. Also, the secondary battery 10a may be curved by pressing the secondary battery 10a at normal temperature without performing a separate heating processing.

In this manner, the secondary battery 10a, according to the present embodiment, is formed to have a predetermined curvature, and the electrode assembly 200 received in the secondary battery 10a is also curved in the same shape as the secondary battery 10a.

Also, since the body 111 and the cover 112 of the battery case 110 are formed of different materials having different stiffnesses, the deformation of the shape of the secondary battery 10a may be prevented.

As described above, according to the one or more of the above embodiments of the present invention, since the secondary batteries are manufactured by using battery cases having different stiffnesses, the shape of the curvature may be maintained to be uniform. Therefore, the reliability of the secondary batteries may be increased.

It should be understood that the exemplary embodiments described herein should be considered in a descriptive sense only and not for purposes of limitation. Descriptions of features or aspects within each embodiment should typically be considered as available for other similar features or aspects in other embodiments.

While one or more embodiments of the present invention have been described with reference to the figures, it will be understood by those of ordinary skill in the art that various changes in form and details may be made therein without departing from the spirit and scope of the present invention as defined by the following claims.

What is claimed is:

1. A secondary battery comprising:
an electrode assembly comprising a positive electrode plate, a separator, and a negative electrode plate wound around a first axis extending in a first direction, having a thickness in a second direction perpendicular to the first direction and a length in a third direction perpendicular to the first direction and the second direction, and having a curvature with respect to the first axis while the length is greater than the thickness;
an electrode case comprising a body and a cover having a curvature corresponding to the curvature of the electrode assembly and having different stiffnesses; and
a first electrode tab and a second electrode tab connected respectively to the positive electrode plate and the negative electrode plate and protruding from the electrode assembly in a direction perpendicular to the first direction.

2. The secondary battery of claim 1, wherein the body and the cover are formed of different materials.

3. The secondary battery of claim 1, wherein the body and the cover are formed to have different thicknesses.

4. The secondary battery of claim 1, wherein when a bottom of the body is convex and a top of the cover is concave, the stiffness of the body is greater than the stiffness of the cover.

5. The secondary battery of claim 4, wherein the body is thicker than the cover.

6. The secondary battery of claim 4, wherein the body is formed of stainless steel, and the cover is formed of aluminum.

7. The secondary battery of claim 1, wherein when a bottom of the body is concave and a top of the cover is convex, the stiffness of the cover is greater than the stiffness of the body.

8. The secondary battery of claim 7, wherein the cover is thicker than the body.

9. The secondary battery of claim 7, wherein the cover is formed of stainless steel, and the body is formed of aluminum.

10. The secondary battery of claim 1, wherein the battery case is formed by using:
a metal foil; and
insulating films stacked on both sides of the metal foil.

11. The secondary battery of claim 1, wherein the battery case is a pouch comprising a sealing portion, and the first electrode tab and the second electrode tab extend through the sealing portion.

12. A secondary battery comprising:
a battery case comprising a body and a cover having different stiffnesses, wherein the cover is bound to the body and a bottom of the body and a bottom of the cover have a curvature in a same direction;
an electrode assembly received in the battery case while having a curvature corresponding to the curvature of the battery case, and comprising a positive electrode plate, a separator, and a negative electrode plate; and
a first electrode tab and a second electrode tab protruding from the electrode assembly.

13. The secondary battery of claim 12, wherein when the bottom of the body and the bottom of the cover have a convex curvature, the stiffness of the body is greater than the stiffness of the cover.

14. The secondary battery of claim 13, wherein the body is thicker than the cover.

15. The secondary battery of claim 12, wherein when the bottom of the body and the bottom of the cover have a concave curvature, the stiffness of the cover is greater than the stiffness of the body.

16. The secondary battery of claim 15, wherein the cover is thicker than the body.

17. A method of manufacturing a secondary battery, comprising:
forming a battery case comprising a body and a cover having different stiffnesses, wherein a bottom of the body and a bottom of the cover have a curvature in a same direction;
receiving an electrode assembly comprising a positive electrode plate, a separator, and a negative electrode plate, in the battery case; and
forming the electrode assembly having a curvature corresponding to the curvature of the battery case.

18. The method of claim 17, wherein when the bottom of the body and the bottom of the cover have a convex curvature, the stiffness of the body is greater than the stiffness of the cover.

19. The method of claim 17, wherein when the bottom of the body and the bottom of the cover have a concave curvature, the stiffness of the cover is greater than the stiffness of the body.

20. The method of claim 17, wherein the body and the cover have different thicknesses.

21. The method of claim 17, further comprising positioning an electrolyte into the battery case.

22. The method of claim 21, wherein positioning the electrolyte into the battery case comprises positioning a gel electrolyte precursor into the battery case.

23. The method of claim 22, wherein the gel electrolyte precursor is positioned into the battery case prior to the battery case being curved.

24. The method of claim 23, wherein the gel electrolyte is thermally cured after the battery case and electrode assembly has been curved.
